(19) United States
(12) Patent Application Publication
(10) Pub. No.: US 2004/0153354 A1
(43) Pub. Date: Aug. 5, 2004

(54) Method and system for managing project program change

(75) Inventors: Hisanori Nonaka, Tokyo (JP); Takeshi Yokota, Tokyo (JP); Kenji Araki, Tokyo (JP); Shigetoshi Sakimura, Tokyo (JP); Youichi Nishikawa, Tokyo (JP); Makoto Kudoh, Tokyo (JP)

Correspondence Address: HOGAN & HARTSON L.L.P., 500 S. GRAND AVENUE, SUITE 1900, LOS ANGELES, CA, 90071-2611, US

(73) Assignees: HITACHI, LTD.; HITACHI PLANT ENGINEERING & CONSTRUCTION CO., LTD.

(21) Appl. No.: 10/763,848

(22) Filed: Jan. 23, 2004

(30) Foreign Application Priority Data
Feb. 3, 2003 (JP) 2003-026129

(51) Int. Cl. G06F 17/60

(52) U.S. Cl. 705/8; 705/9

(57) ABSTRACT

The present invention provides a project program change management system which is combined with a means of program change inference that traces or infers and specifies the tasks and the milestones that are directly and indirectly influenced by the program change and a means of program change notice that automatically inform the program change notices to the stake holders who are relevant to the tasks and the milestones that are influenced by the project program change. By using this system, it can be possible to eliminate the troubles in communication carried on with the project.

### FIELD OF THE INVENTION

The present invention relates to a method and a system that support to manage projects such as constructions of electric power plant and chemical plant, developments of computer software and commercial products and operations of product manufacturing.

### BACKGROUND OF THE INVENTION

In the program planning for constructions of electric power plant and chemical plant, developments of computer software and commercial products and operation of product manufacturing, it is not only important to project the initial project program but also to change the project program to meet the on-going status and new requirements and appropriately manage the record of the modification caused by such a project program change.

If such modification record is not appropriately managed, the information of change or modification of the term and due date for the task and milestone cannot be notified to stake holders who are participating to the project. For the lack of appropriate communication between the project management body and the stake holders, there is a risk of trouble such as additional expense due to influential problems happened in other processes by a lack of necessary information.

Conventional technologies that support to manage the change of the project program have been proposed as follows.

“MANAGEMENT AND INQUIRY SYSTEM FOR CONSTRUCTION PROGRESS STATE” described in the reference 1 records and manages the information with regard to the progress status of the building construction and the past information and the updated information of progress status obtained before and expected after the modification of the information caused by the change of building construction program or by the change of the details of construction operation and allows to inform the progress status anytime on request or necessity.

“PRODUCTION PLAN PREPARING DEVICE AND MEDIUM” described in the reference 2 enables to modify the daughter manufacturing process in conjunction with the modification of the mother manufacturing process.

“METHOD AND DEVICE FOR MANAGING INTER-COMPANY TRANSACTION PROGRESS” described in the reference 3 enables to evaluate transaction progress on the basis of the inter-company transaction information communicated through network and to inform the subsequent companies of the status if delay of the transaction is found.

“SYSTEM FOR MANAGING PRODUCTION PROCESS PROGRESS” described in the reference 4 enables to retrieve other processes that may be influenced by a change of plan of the arbitrarily selected process in a series of production processes and to change the production plan.

“CONSTRUCTION PROCESS CONTROL METHOD AND DEVICE” enables to provide a parent device and child devices, which communicate each other through radio communication, co-owing the schedule and the progress of the construction process each other.

These conventional technologies are effective and useful in co-owing the information and support the consistency of the information when a change of the process happens. However it is not sufficient to merely co-own the information that has been modified and updated by the change of the process. It is preferable to subjectively and possibily inform the modification and the affects due to the change of the process to stake holders who may be influenced by or suffered from the change of the process, such as customers, sales persons, the persons in change of the project in the suppliers, the persons in charge of the task and the project leader.

The change of the process influences to the plural tasks composing the project execution and milestones set in the schedule. It is quite necessary to consider and review the tasks and milestones which may be indirectly influenced by the change as well as those directly influenced. In addition, it is necessary to consider the restrictions such as the limited exchangeability or alternation of tasks or milestones, limitation of the contracted terms and confinement of resources such as head counts of working persons, materials, equipments and financial budgets.

Assessing the conventional technologies from these points of views, several insufficiencies are found therein. The technology described in the reference 1 has a capability to inform a warning to the owner but has no function to trace or infer the influence caused by the process change up to the subsequent processes. The technology in the reference 2 has no function to inform the stake holders of the modification regarding the process change.

The technology described in the reference 3 has a capability to evaluate the progress by using the information of the inter-company transaction but no function to trace or infer the influence caused by the process change up to the subsequent processes. The technologies described in the references 4 and 5 have no function to inform the stake holders of the influences caused by the process change. As the conclusion, all of these conventional technologies have insufficiency in the functionality.

### BRIEF SUMMARY OF INVENTION

The present invention has advantages to infer and specifies the tasks and milestones that may be directly or indirectly influenced by the change of the process and to automatically inform the stake holder of the appropriate information regarding the modification caused by such changes. By using this technology, it is possible to eliminate the troubles and the potential risks in the communication with the stake holders.

One of the solutions to solve the conventional technologies is to have a capability to inform appropriate information to the stake holders who are relevant to the tasks or the milestones which may be directly or indirectly influenced by the modified project program which can be obtained by tracing or examining the influence caused by the process change.

### BRIEF DESCRIPTION OF THE DRAWINGS

FIG. 1 is a system construction drawing of the project program change management system according to the first embodiment of the present invention.

FIG. 2 shows a Gantt chart (1) of a sample of Planning Master.

FIG. 3 shows a sample of Planning Master Data and Restrictive Condition Data (1).

FIG. 4 is an example of the process flows in Program Change Influence Inference Functional Unit 104

FIG. 5 is an example of the results after the process flows in Program Change Influence Inference Functional Unit 104.

FIG. 6 is a set of the stake holder information (1).

FIG. 7 is another set of stake holder information (2).

FIG. 8 is an example of the process flows carried out in Program Change Notice Functional Unit 105.

FIG. 9 is an example of sets of data to compile Program Change Notice.

FIG. 10 shows a Gantt chart (2) of a sample of Planning Master.

FIG. 11 shows a sample of Planning Master Data and Restrictive Condition Data (2).

FIG. 12 is an example of Program Change Notice.

FIG. 13 is a system construction drawing of the project program change management system according to the second embodiment of the present invention.

FIG. 14 shows an example of a pair of Program Change Notice and Program Change Reply.

FIG. 15 shows another example of Program Change Reply.

### PREFRRED EMBODIMENT OF THE INVENTION

First Embodiment

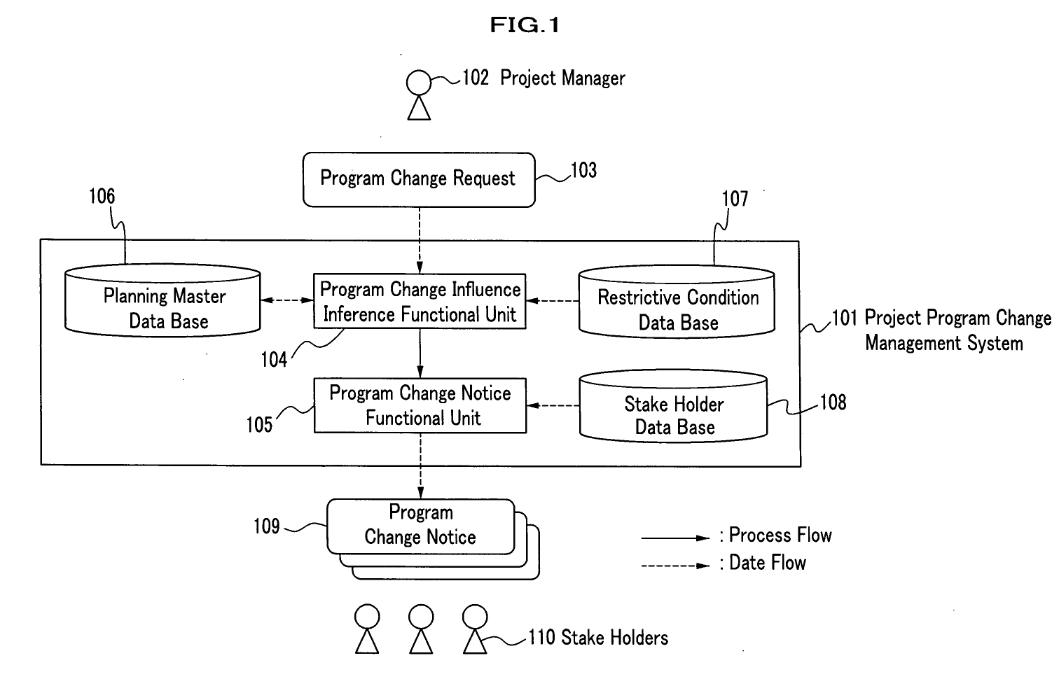

The first embodiment of the present invention will be explained by the FIG. 1 that shows the construction of the project discussed by the first embodiment which has a construction of a management system for managing project program changes. The management system for managing project program change called a “project program change management system” (noted by 101) has an input capability to receive an input for program change request 103. The program manager 102 has an authority to change or modify the processes that compose the project operation.

The project program change implies the project modification that is to change or modify the elements that are relevant to the execution of the project, such as schedule of project execution and the scope of the project. More concretely, the project program change includes the starting date or ending date of the task performed in the project, the working term of the task, the attributes and attribution of the persons in charge for the task, plans for operators and materials, plans for equipments and machineries, the budgetary plan, the specifications of the fruits of the project such as planned power generation of generator plant and the contents of the agreement prescribed in the contracts. In other words, some of the examples of project programs to be changed or to have been changed cover process programs, financial budgets, head count budgets of working persons, organization changes, material budgets, risk management programs, procurement programs, quality control programs, operation rules and elemental prescriptions of contracted agreements.

The project program change management system 101 comprises three data bases noted as 106, 107 and 108 and two functional units 104 and 105 for program change influence inference and for program change notice 109. They are called “Program Change Influence Inference Functional Unit 104” and “Program Change Notice Functional Unit 105”, respectively. The former functional unit is to infer and specify how the project program change directly or indirectly influences the execution of the project. The latter functional unit issues a change notice 109 to the stake holder 110 who is relevant to the tasks or milestones which are expected to be influenced by the results given from the Program Change Influence Interference Functional Unit 104. The stake holder 110 is usually an orderer, a task manager or a worker and includes several categories of people.

In the process done by Program Change Influence Inference Functional Unit 104, the information of the process and resources relevant to the project that is stored in Planning Master Data Base 106 and the information of the restrictive condition that is limitation elements in the project stored in Restrictive Condition Data Base 107 are used.

The “restrictive condition” means a condition prescribing the limitation that restricts the means or the purposes to achieve the goal of the task, milestone or others such as the elements composing the project execution. For example, the strict application of the sequential order of task execution or milestones, the due date of the contracted matters, operators, materials and equipments and machineries which are necessary for carrying out the tasks and the other limitation of resources such as the financial expenses etc., are included.

Program Change Notice Functional Unit 105 uses the relational information to make a linkage between the stake holders to be informed of the program change notice when Program Change Influence Inference Functional Unit 104 infers and specifies influences in the execution of the project. In this embodiment, the relational information is obtained by the function of a relational data base implemented in Stake Holder Data Base 108.

As explained above, it is possible to automatically inform the stake holder 110 of the appropriate information regarding the modification caused by the change of the tasks and milestones that may be directly or indirectly influenced by the change of the process by using Project Program Change Management System 101 provided by the present invention. Due to the capability of this system, it is possible to eliminate the troubles and the potential risks in the communication with the stake holders regarding the project program changes so that Project Program Change Management System 101 allows the management to execute a smooth and flawless execution of the project.

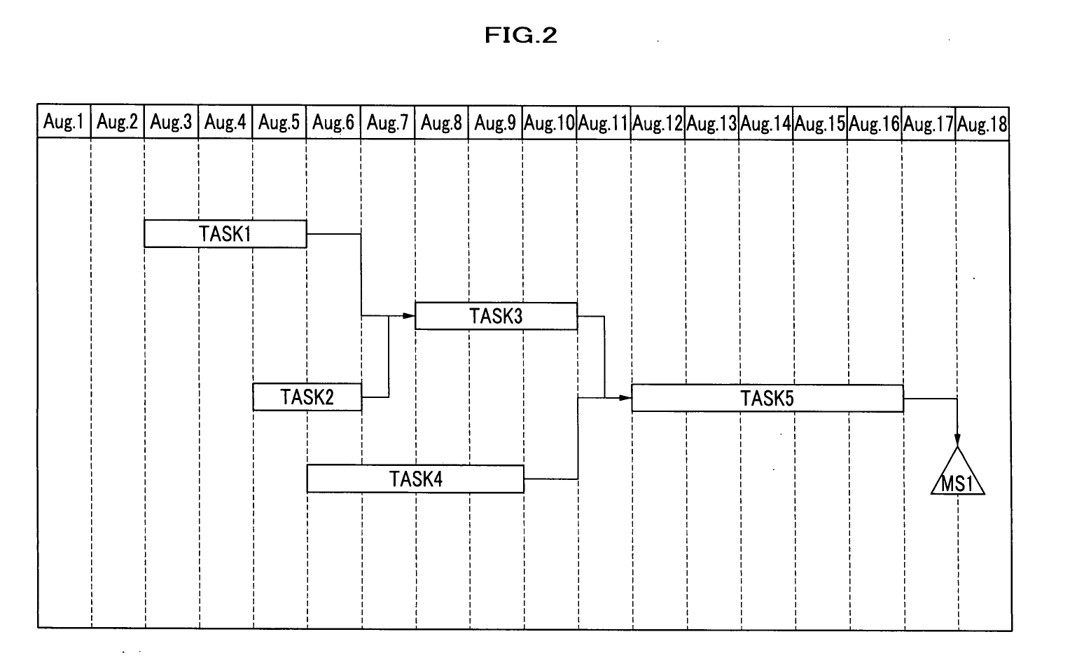

By using an example of a simple project shown in FIG. 2, a sequential flow carried out in the function of Project Program Change Management System 101 from tracing the influence caused by the process change to informing a notice to the stake holders of the influence caused by the process change.

The project consists of five tasks as TASK1 to TASK5 and a mile stone as MS1. The restrictive condition among the tasks is a sequential order which has been indicated by “arrow” sign. For example, the task TASK3 cannot start before both tasks as TASK1 and TASK2 have been completed.

The preceding tasks for the task TASK3 are the tasks TASK1 and TASK2. The preceding tasks for the task TASK5 are the TASK3 and TASK4 and the preceding task for the milestone MS1 is the task TASK5.

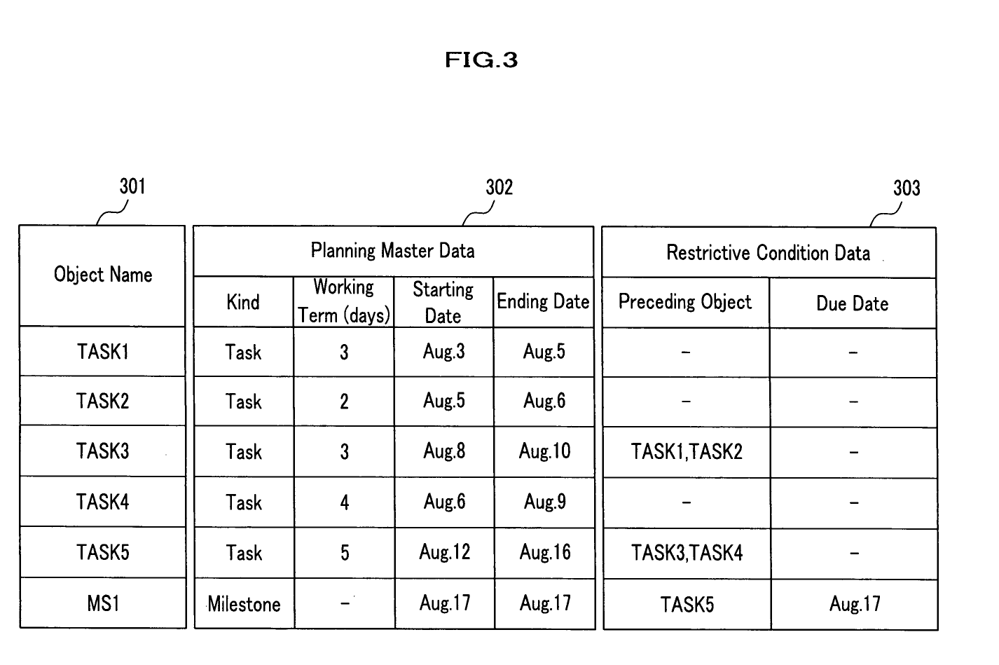

FIG. 3 shows Planning Master Data 302 and the Restrictive Condition Data 303. Each datum corresponds to each Object Name 301 (which is same as the task name or the milestone name in this example). The Planning Master Data 302 is stored in the Planning Master Data Base 106 and the restrictive condition data in Restrictive Condition Data Base 107.

The Planning Master Data 302 has items as Kind, Working Term, Starting Date and Ending Date in this example. The milestone MS1 has no working term and is in a special case such that the starting date and the ending date coincide with each other.

For the purpose of simplicity, two restrictive conditions as the sequential order and the due date agreed in the contract are incorporated. Therefore, the preceding object and the due date are given as the data item used for Restrictive Condition Data 303.

The restrictive condition for the preceding object coincides with that of the preceding tasks shown in FIG. 2. The restrictive condition for the due date is give as August 17 th for the milestone MS1.

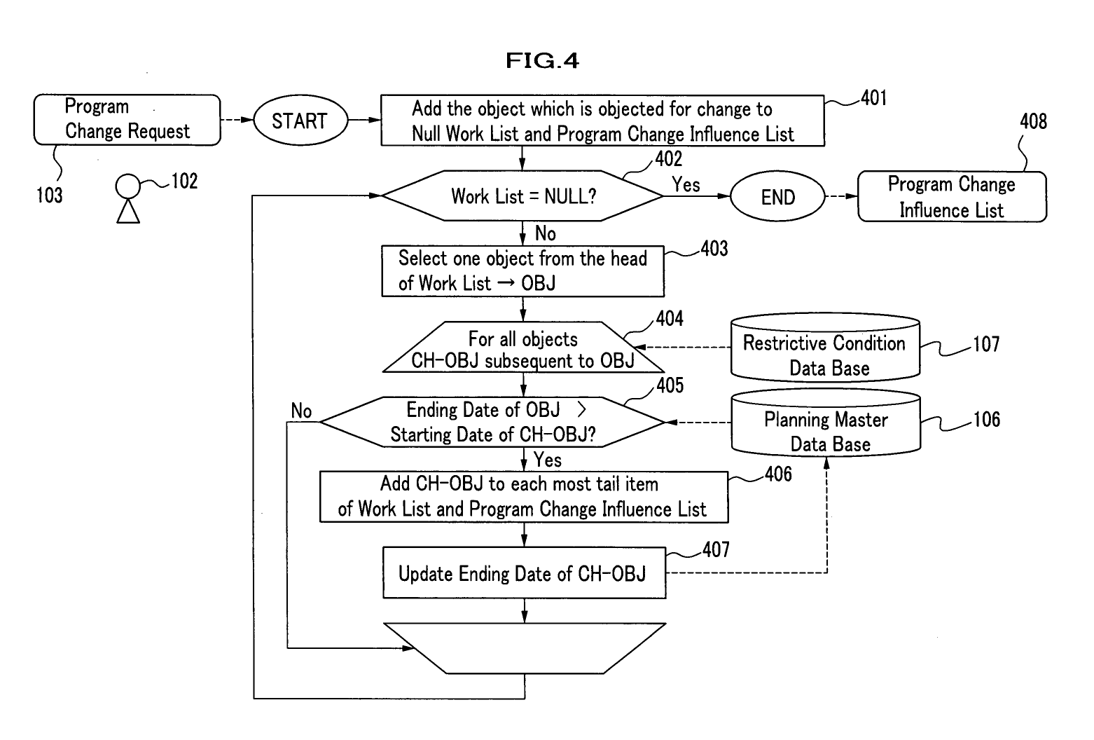

FIG. 4 shows the process flow in Program Change Influence Inference Functional Unit 104 for the case when the due date of an arbitrarily selected object has been changed.

When Program Change Influence Inference Functional Unit 104 receives Program Change Request 103, two null lists (such as a work list and a program change influence list) are opened and the names of the objects which are to be changed are added.

The step 402 is a judgment step to jump to END that is the process termination for the case when the work list is NULL. In the step 403, an object is selected from the head of the work list and is indexed to the work variable OBJ.

The step 404 implies the iteration of the processes given by the steps 404 and 405 regarding all subsequent objects (noted as “CH-OBJ”) after the work variable OBJ. The subsequent objects imply a group of all of the objects which have the present noticed object as a preceding object. They can be obtained from the preceding object data itemized in Restrictive Condition Data 303 stored in Restrictive Data Base 107.

For example, the subsequent object of the tasks TASK1 and TASK2 is TASK3, the subsequent object of the tasks TASK3 and TASK4 and the subsequent object of TASK5 is the milestone MS1.

At the step 405, the ending date of the work variable OBJ is compared with the starting date of the subsequent object CH-OBJ on the basis of the data stored in Planning Master Data Base 106. If the ending date of the subsequent object OBJ is delayed from the starting date of the subsequent object, it means that the subsequent object CH-OBJ has been indirectly influenced by the change. At the step 406, the subsequent object CH-OBJ is added onto the most tail item of the work list and the program change influence list.

At the step 407, the ending date of the subsequent object CH-OBJ which has been influenced by such delay of the ending date of work variable OBJ is updated. The method of updating should be set to be compliant to the properties of the object. The simplest method is that the ending date is delayed by the same delay as the delay of the starting date. In this process, it is possible to calculate the delay for each of the objects, it may be preferred that such delay information is recorded in the program change influence list for future use as the information of better to manage the influence.

All processes through steps from 403 to 407 are iterated until the work list at the step 402 becomes a null set.

By all throughout processes, the names of objects which have been directly or indirectly influenced by the program change request 103 (specifically the change of the ending date of the object which is objected for change) are recorded in Program Change Influence List 408.

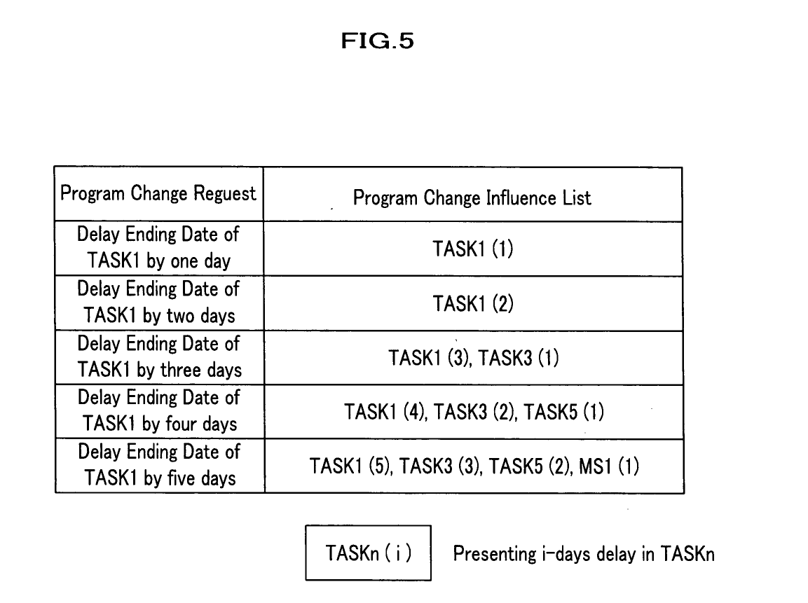

FIG. 5 shows an example of the corresponding relation between the program change request 103 and the program change influence list compiled by the process carried out in Program Change Influence Inference Functional Unit 104.

FIG. 5 shows a resultant table of the program change influence list for such an example that the ending date of the task TASK1 is delayed by one to five days. For instance, if the ending date of the task TASK1 is set to be one-day delayed, no objects are influenced by this delay and the direct effect as “TASK1 delays one day” is indicated in the program change influence list.

For other examples, the task TASK3 is indirectly influenced by such a delay that the task TASK1 delays three days, the task TASK5 is indirectly influenced by such a delay that the task TASK1 delays four days and the milestone MS1 is indirectly influenced by such a delay that the task TASK1 delays five days.

Project Manager 102 can immediately recognize the influence against the project due to the change or modification he has done or intends to do by using the results as shown in FIG. 5. Therefore he or she can appropriately evaluate and judge the change or modification done or to be done in the project.

The details of Program Change Notice Functional Unit 105 will be explained. An example of the stake holder information (1) used in the process carried out in Program Change Notice Functional Unit 105, which is stored in Stake Holder Data Base 108, is shown. The stake holder information (1) shows the correspondence between the objects in the project and the stake holders who are relevant to the objects.

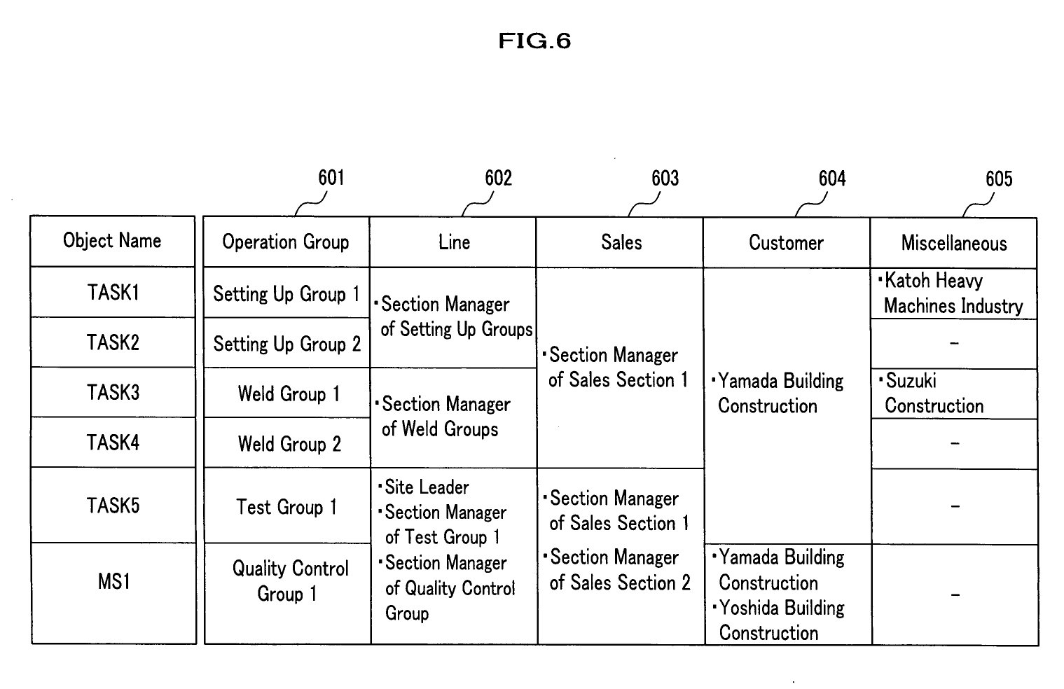

In the example shown in FIG. 6, the information of the stake holder is itemized into five items: Operation Group 601, Line 602, Sales 603, Customer 604 and Miscellaneous 605. Each object is indicated to the specific information shown in all of these items.

For example, the task TASK1 is relevant to the setting up group 1 which is an operation group, the section manager of the setting up group 1 which is line information, the section manager of sales section 1 which is in charge of Sales, Yamada Building Construction which is customer information and Katoh Heavy Machines Industry which is miscellaneous information. The category of the item should be improved on necessity from time to time.

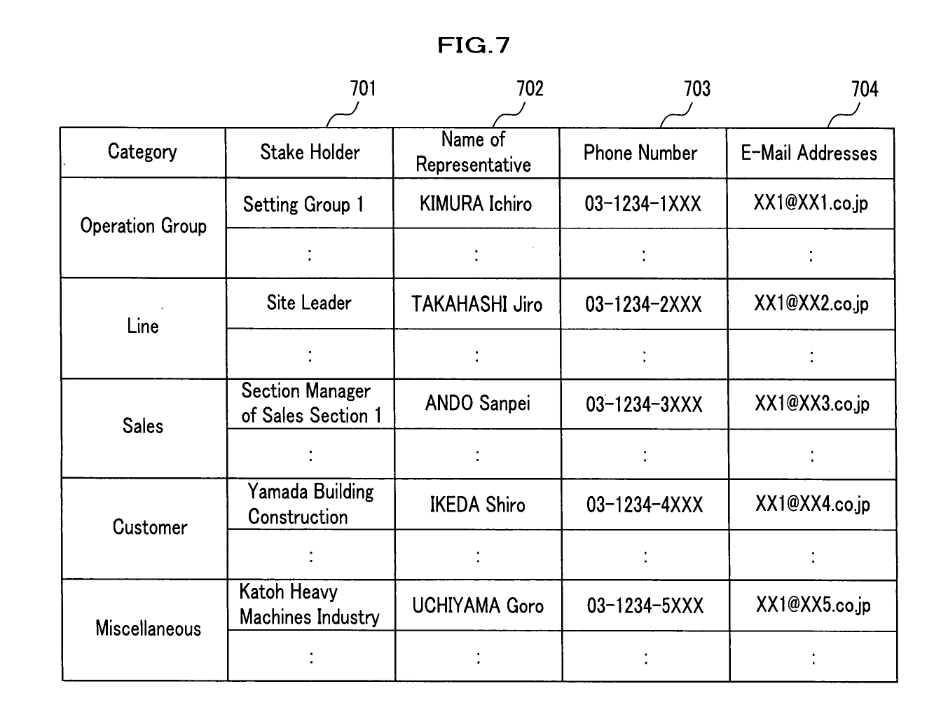

Stake Holder Data Base 108 includes the stake holder information (2) as shown in FIG. 7. The stake holder information (2) shows the correspondence to the information such as the name of the representative 702, his or her phone number and e-mail addresses, all of which are the attribution information of each of the stake holders.

For example, the name of the representative of the setting up group 1 is “KIMURA Ichiro” and his phone number is “03-1234-1XXX” and the e-mail address is “XX1@XX1.co.jp”. The attribution items should be improved on necessity from time to time.

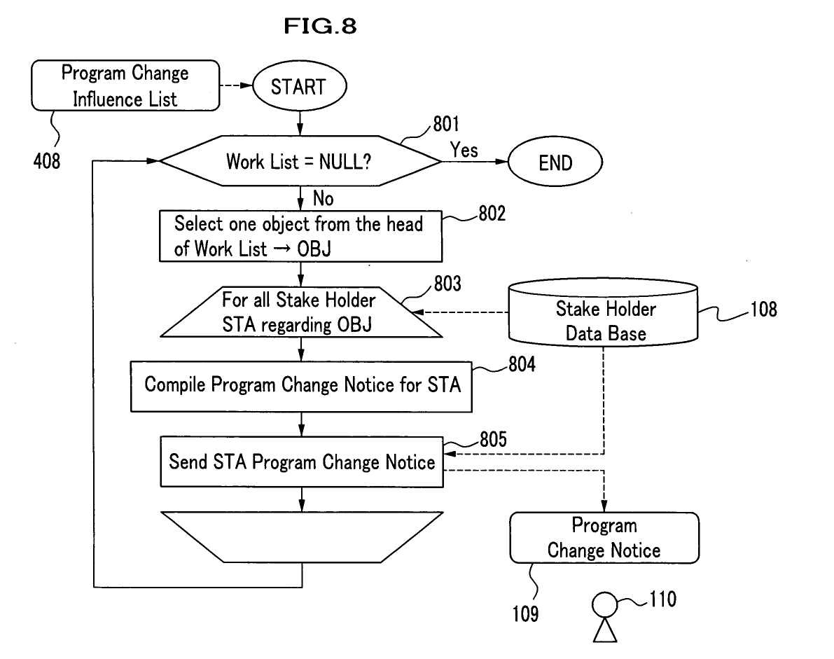

FIG. 8 shows an example of a flow carried out in Program Change Notice Functional Unit 105. The flow is initiated by the event that Program Change Notice Functional Unit 105 receives Program Change Influence List 408 complied by Program Change Influence Inference Functional Unit 104. The step 801 is a judgment step to jump to END to terminate the flow of processes when the program change influence list is NULL.

In the step 802, an object is selected from the head of the program change influence list and is indexed to the work variable OBJ. The step 803 implies an iteration of the step 804 and the step 805 from all stake holders STA relevant to OBJ.

At the step 803, the stake holder information (1) stored in Stake Holder Data Base 108 is used since all of the stake holders relevant to OBJ are extracted. At the step 804, “program change notice” that notifies the influence caused by the process change is compiled. At the step 805, this Program Change Notice 109 is sent to the stake holder STA.

At the step 805, the stake holder information (2) stored in Stake Holder Data Base 108, that is the attribution information of the stake holders, is used in order to obtain the correspondence information of the stake holder STA.

Concrete sending means to send Program Change Notice 109 are preferred to be electric mail, facsimile, automatic telephone by voice synthesizer, voice mail and instant messaging. In addition the other sending means that are suitable for the operation environment under which the project program change management system according to the present invention is operating can be used for such purpose.

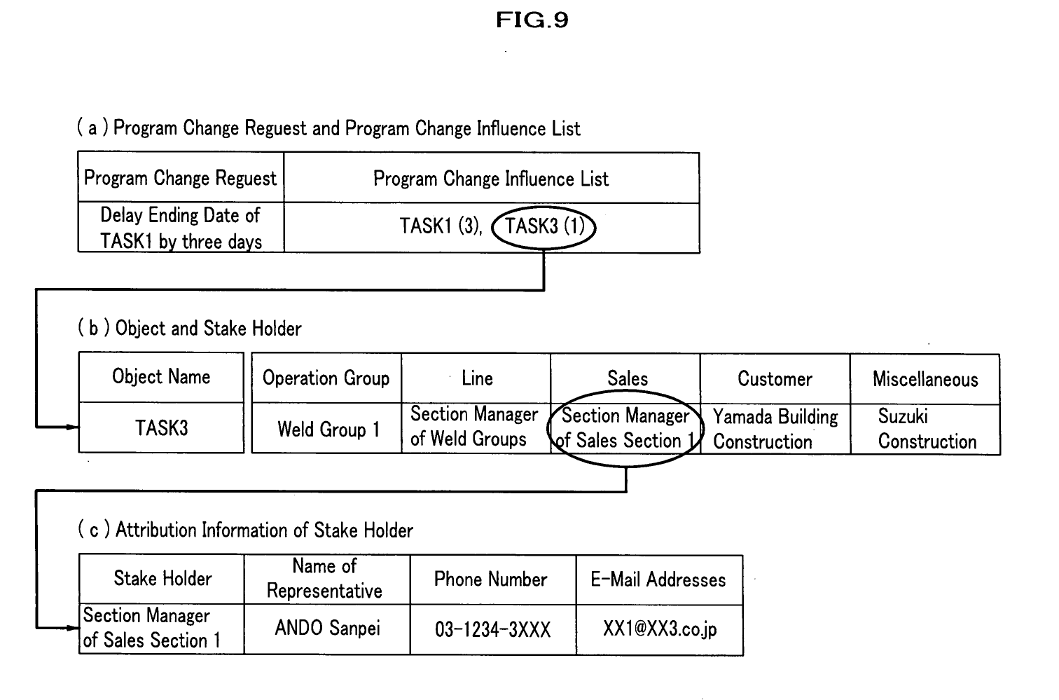

An example of the program change notice is explained in FIG. 9. As a sample, when the “three-days delay in the ending date of TAKS1” is requested, an influence, that is, the task TASK1 delays by three days and the task TAKS3 delays by one day is inferred and specified by Program Change Influence Inference Functional Unit 104.

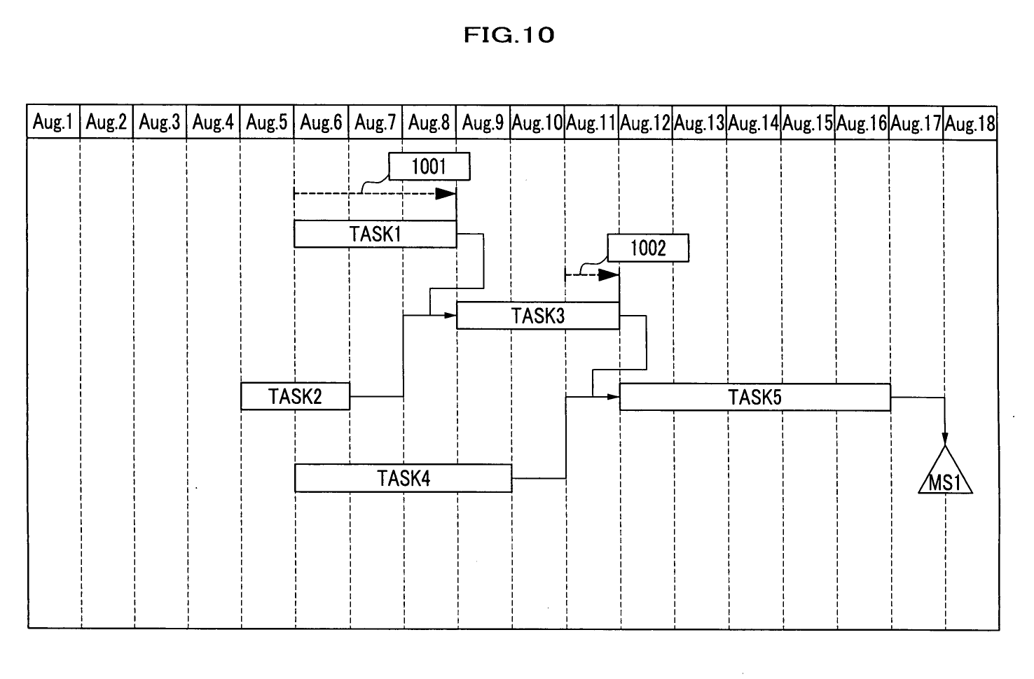

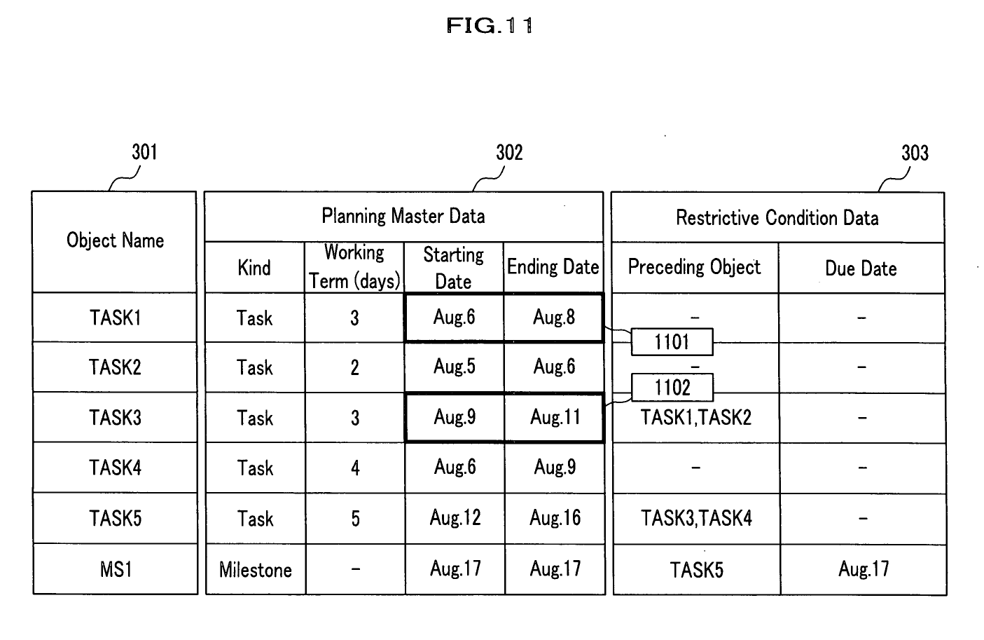

FIG. 10 shows how the sample of the planning master has been modified. The arrow signs 1001 and 1002 indicate the delays of the ending dates of TASK1 and TASK2. The samples of the planning master data and the restrictive condition data which correspond to FIG. 10 are shown in FIG. 11. It can be found that the starting date and the ending date 1101 of the task TASK1 surrounded by a rectangle and the starting date and the ending date 1102 of the task TASK3 surrounded by a rectangle have been modified.

In this example, the task TASK1 is a direct object to be modified or changed. The task TASK3 is indirectly influenced by the modification of TASK1. As shown in FIG. 9B, the details of the task TASK3 regarding the relevant stakeholder according to the result of a flow carried out in Program Change Notice Functional Unit 105 are “Weld Group 1”, “Section Manager of Weld Groups”, “Section Manager of Sales Section 1”, “Yamada Building Contraction” and “Suzuki Construction”.

The program change notice regarding the task TASK3 is to be notified for these five stake holders. Further details of the stake holders can be obtained. For example, the attribution of “Manager of Sales Section 1” is obtained such as the manager name of Sales Section 1, the telephone number, the electric mail address as shown in FIG. 9C by the result of a flow carried out in Program Change Notice Functional Unit 105.

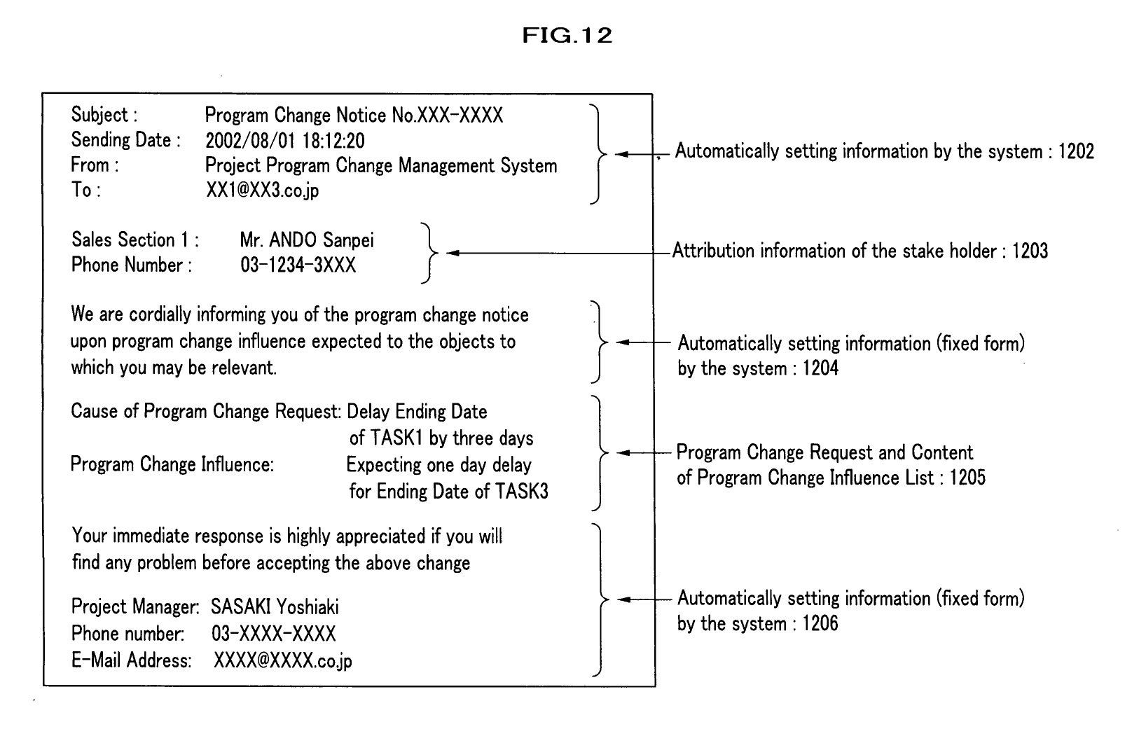

A program change notice example 1201 is shown in FIG. 12 which is complied on the basis of the detailed data of the stake holder in FIG. 9. A program change notice by using an electric mail is supposed. The information 1202 that is the subject of mail, sending date and the sender's name is automatically set the system.

“Subject” of the electric mail is preferred to have a consistent control number. The attribution information 1203 such as the mail address, the representative person and the phone number of the stake holder to whom the electric mail of the program change notice is sent is to automatically be compiled by the information as shown in FIG. 9C.

The sentence 1204 is the introduction of program change notice and a fixed form that the system automatically sets. The sentence 1205 that shows the program change request and the content of the program change influence list are complied by the system on the basis of the information as shown in FIG. 9A. The sentence 1206 that describes the correspondence information of the project manager is automatically set by the system.

By using the project program change management method of the present invention, the program change notice 1201 is automatically sent to the stake holders and the information of project program change and the program change influence can be immediately co-owned by the project manger or the project managing division and the stake holder.

By this invention, it is possible to reduce the communication troubles and quickly take countermeasures against the occurrences of the project program changes. Therefore it is possible to raise a smart project management and to improve the quality of the products manufactured by the project.

In the above example, the detail discussion has been given for the case such that the ending date of the object is change or modified for the purpose of the simplicity in the explanation. However the object of the present invention is not confined in such case. For example, it is possible to infer and specify the influence for the case such that the starting date of the object is changed or modified by using the similar flow carried out as shown in FIG. 4. By making a rule of the influence for the delay of the starting date, the flow shown in FIG. 4 is applied as is.

When the object is early started, the program change influence can be processed by renaming the subsequent object as the preceding object and modifying the step 405 to “OBJ Starting Date<CH-OBJ Ending Date?”.

In the above example, an extreme case such that the ending date of the preceding task delays to be after the starting date of the subsequent task so that the program change influence is obviously expected has been explained. However in a practical project management aspect, it is preferred that the program change notice is sent to the stake holder on the right time when the possibility of the influence against the tasks is implicitly expected by the system.

For example, the ending date of the task TASK1 delays three days in the example shown in FIG. 10, the ending date of the task TASK3 obviously delays one day. On the other hand, the delay explicitly has no influence against the task TASK5. However there is no time margin between tasks TASK1 and TASK3 or that between tasks TASK 3 and TASK5. Therefore, once the task TASK1 or TASK3 slightly delays, it is expected that the start of the task TASK5 is immediately influenced by such delay.

For this case as expecting a potential delay in the task TASK5, if the system may send a warning message to the stake holder who is relevant to the object that has a potential risk of the delay of operation, then it is possible for the stake holder to make an appropriate countermeasure beforehand, that results into a quality improvement in the project management.

It is practical to determine the criterion to raise a warning in relation to the specific properties of the projects and no specific design for the warning is discussed in the present invention. For example, the criteria to send warnings may be the cases that no time margin has been left in the preceding object for the current object and that no time margin has been left for the subsequent object which has a fixed due date.

In the followings, another embodiment of the present invention will be discussed. When the project leader changes or modifies the project program, the contents of the contract or design specifications, it is frequently requested to obtain not only approvals of the stake holders but also their acknowledgements.

For example, if the modification or change of a certain task may influence other tasks, then it is necessary to ask a confirmation for approval such as whether it may not be a problem in the modification or the change for the stake holders who may be relevant to the task before the data of the planning master will be modified. In the second embodiment of the present invention, the system which manages the process for such approval is proposed.

Second Embodiment

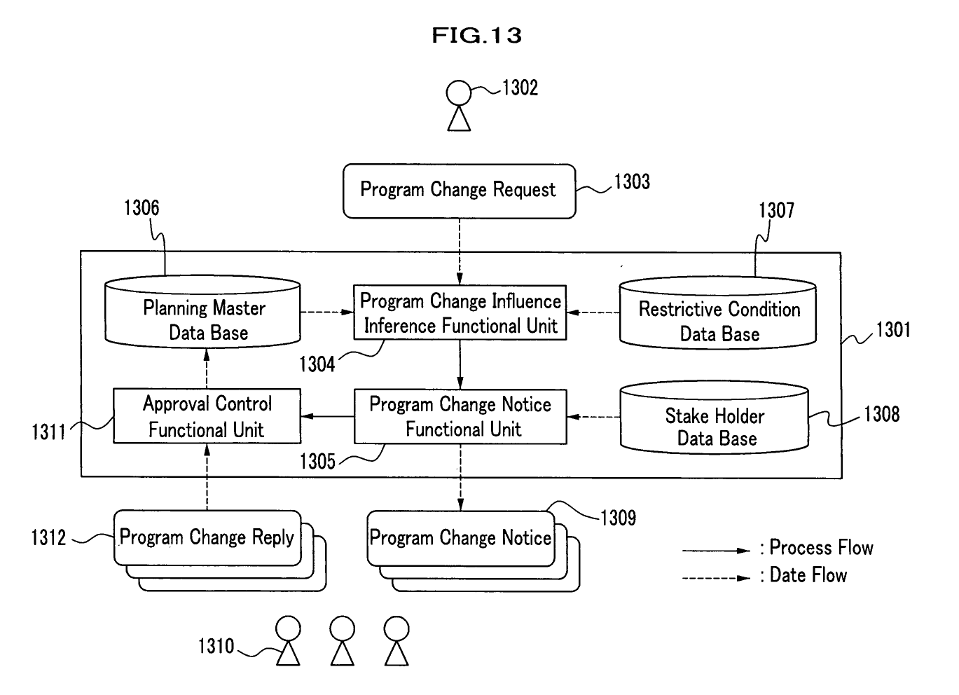

FIG. 13 shows the second embodiment of the present invention. Since the notations 1301 to 1310 denotes the same subjects as shown in the notation 101 to 110 as used in FIG. 1, the explanation is omitted. When the stake holder 1310 receives Program Change Notice 1309, he or she checks the content of the notice and sends back Program Change Reply that describes whether he or she approves the change or the modification to Approval Control Functional Unit 1311.

Approval Control Functional Unit 1311 retrieves and manages Program Change Reply 1312 sent by each stake holder 1310 and notifies to the project manager of the status of the reply or displays such status on the terminals. Once the change or the modification has been approved, the data stored in Planning Master Data Base 1306 is updated on the basis of the information of the approved Program Change Reply.

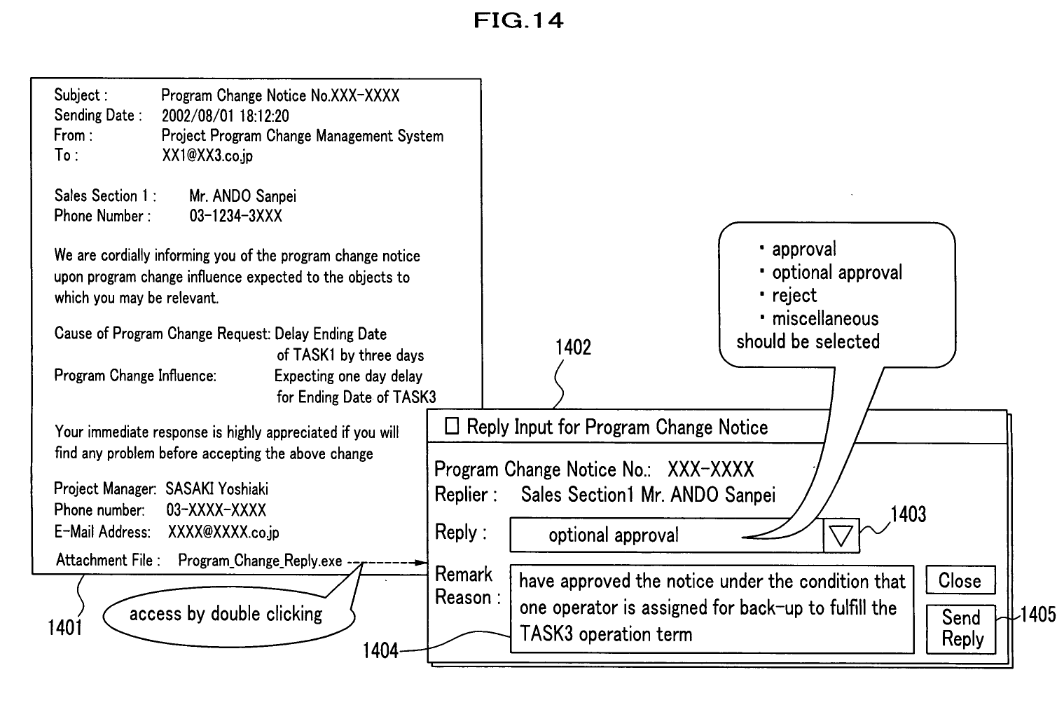

Program Change Reply 1312 is concretely done by the stake holder using an electric mail or an instant message, of which formats are compliant to the pre-determined format. It may be considered that the case such that the stake holder inputs onto WWW Browser, but the present invention does not confine to using such input for the communication. For example, FIG. 14 shows the case when a reply to the mail message of Program Change Notice as shown in FIG. 12 is created with a input reply format of the program change called Reply Input for Program Change Notice 1402 where the series number of the program change notice and the name of the replying person (that is the stake holder and the name of the representative) are automatically formed on the basis of the electric mail message of Program Change Notice.

Reply Input for Program Change Notice 1402 is accessed by double clicking the series of words “Program_Change_Reply.exe” in the graphics of mail message of Program Change Reply as shown in FIG. 14. In Reply Input for Program Change Notice 1402, it is possible to obtain the series number of the program change notice and the name of the replying person (that is the stake holder and the name of the representative) are automatically formed on the basis of the electric mail message of Program Change Notice.

A Stake Holder 1310 selects a desired reply from Dropdown List 1403 for replies. The selections for the reply are considered to be “approval”, “optional approval”, “reject” and “miscellaneous”. FIG. 14 shows the case when optional approval is selected.

In the remark and reason window 1404, Stake Holder 1310 can input an arbitral text and he or she can describe a supplemental statement for his or her reply. FIG. 14 shows the supplemental statement for the optional approval as “have approved the notice under the condition that one operator is assigned for back-up to fulfill the TASK3 operation term”.

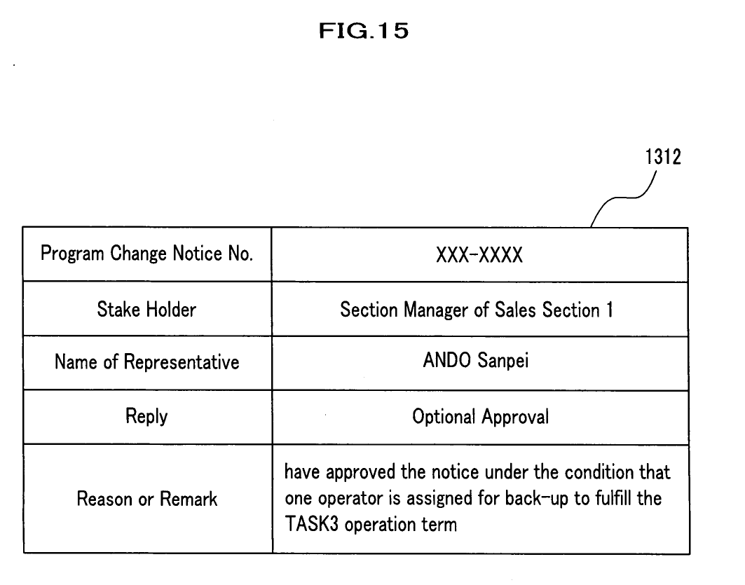

The information of Program Change Reply 1312 as shown in FIG. 15 is sent to Approval Control Functional Unit 1311 by clicking Reply Sending Window 1405 after inputting above information. In Approval Control Functional Unit 1311, the following processes are carried out;

(1) Receiving and retrieving Program Change Reply 1312 sent by Stake Holder 1310.

(2) Receiving the information of the time when the program change notice was sent from Program Change Notice Functional Unit 105 and the information such that to which stake holder the program change notice has been sent from Program Change Notice Functional Unit 105, identifying the stake holder who does not send the Program Change Reply 1312 in a certain predetermined term and sending Project Manager 1032 a notice of the information. In addition, a follow-up mail being automatically sent to the stake holder.

(3) For Project Manager 1302, informing a list regarding or displaying which stake holder has replied and what sort of replies he or she has sent back.

(4) The data in Planning Master Data Base 1306 being updated on the bases of Program Change Influence List 408 when all relevant stake holders have accepted an arbitral project program change, the stake holders approve the updating of Planning Master Data Base 1306 on the basis of the predetermined criterion or Project Manager 1302 directs the updating.

(5) The content of Program Change Influence List 408 being complied by the direction of Program Manager 1302.

As has been explaining, it is possible to carry out the project change or modification on the bases of the consent of the stake holders by installing Approval Control Functional Unit 1311 in Project Program Change Management System 1301 and it is possible to improve convincing and the high-quality managing for the project program changing.

In the above embodiment, the change or modification of the operation term of the object is only discussed for the purpose of simplicity. However, the changes or the modifications of the object in the project in the present invention are not confined in the project term such as starting dates, ending dates or the terms of operation of the tasks in the project but also the attribution of the persons in-charge, the resources such as planning in materials, equipments and financial budgets, the resultant products (for example the planned power generation of generator plant) or the contents of the agreements of prescribed in the contracts.

The logic of rule in the influence of the change or the modification of the objects as discussed above against other objects depends on the restrictive condition among the objects (namely informative linkage) and not confined into a specific logic however it is satisfied with the generalization of the inferring process carried out in Program Change Influence Inference Functional Unit 104 shown in FIG. 4.

For example, when the ending date of the task TASK1 is delayed by five days, three tasks as TASK1, TASK3 and TASK5 are influenced by the delay. Moreover the milestone MS1 that has the task TASK5 as a preceding object as well as these tasks is influenced as well as these tasks. On the other hand, the due date agreed in the contract, that is the ending date of the milestones MS1, is fixed as August 17 th.

In other words, the object of the milestone “MS1” is linked with the contract object as “term 1-2-3 in the agreement” through the restrictive condition as “due date”. In order to change the ending date of MS1, it is necessary to obtain the approval from the stake holders who are relevant to the item 1-2-3 of the agreement.

By using the management method and the management system regarding the project program change management system in the present invention, it is possible to infer and specify the influence to other objects in the project at the time when the change or modification of the objects in the project, such as the tasks, the milestone or the attribution of the term of the resources and quantity of the use of the resources has been planned or has been done. The information of inference can be sent to the stake holders who are relevant to the objects that would be influenced thereby.

As discussed above, it is possible to eliminate the troubles and the potential risks in the communication with the stake holders regarding the project program changes, allow the management to execute a smooth execution of the project and expect the increase of profit obtained from the project.

What is claimed is:

1. A project program change management system comprising:
an input means to input a project program change regarding arbitral objects that compose works of a project,
a project change influence inference means that infers and specifies objects which are influenced by said project program change in response thereto,
a stake holder inference means that infers and specifies stake holders who are relevant to said objects inferred and specified in said project change influence inference means, and;
a information notice means that notifies information regarding influence of contents of program change to stake holders who are inferred and specified by said stake holder inference means.

2. A project program change management system comprising:
an input means to input a project program change regarding arbitral objects that are works such as construction, development and manufacturing of a project,
a project change influence inference means that infers and specifies objects which are influenced by said project program change in response thereto,
a stake holder inference means that infers and specifies stake holders who are relevant to said objects inferred and specified in said project change influence inference means, and;
an information notice means that notifies information regarding influence of contents of program change to those stake holders who are inferred and specified by said stake holder inference means, wherein;
said project change influence inference means infers and specifies objects that are to be influenced by said project program change by using information, being stored in a data storage means therein, of the restrictive condition regarding said project.

3. A project program change management system comprising:
an input means to input a project program change regarding arbitral objects that are works such as construction, development and manufacturing of a project,
a project change influence inference means that infers and specifies objects which are influenced by said project program change in response thereto,
a stake holder inference means that infers and specifies stake holders who are relevant to said objects inferred and specified in said project change influence inference means, and;
a information notice means that notifies information regarding influence of contents of program change to those stake holders who are inferred and specified by said stake holder inference means, wherein;
said stake holder inference means that infers and specifies stake holders who are relevant to said objects which are to be influenced by said project program change by using information, being stored in a data storage means therein, of peoples and organization regarding said project.

4. A project program change management system according to claim 3, wherein;
a process that manages information regarding approvals given by said stake holders and stores said information in a data storage means is included.

5. A project program change management system according to claim 1, wherein;
project programs to be changed or to have been changed in said project program change cover process programs, financial budgets, head count budgets of working persons, organization change, material budgets, risk management programs, procurement programs, quality control programs, operation rules and elemental prescription of contracted agreements.

6. A project program change management system according to claim 1, wherein;
a process to infer and specify objects which are to be influenced by said project program change on a basis of a predetermined criterion for evaluating influence against said objects is included.

7. A project program change management system according to claim 6, wherein;
an initial data regarding project programs is updated only when all relevant stake holders accept an arbitral project program change or said stake holders approve updating of said initial data regarding project program on a basis of a predetermined criterion for evaluating said updating.

8. A project program change management system according to claim 2, wherein;
said information, being stored in a data storage means therein, of the restrictive condition regarding said project includes at least sequential order of tasks or milestones, due date of contracted matters, available financial budget and operators, an upper limit of quantity of materials, equipments and machineries and restrictive condition based on operation rules and elemental prescription of contracted agreements

9. A project program change management system according to claim 1, wherein;
a process to infer and specify not only direct but also indirect influences by said project program change is included.

10. A project program change management method comprising:
an input step to input a project program change regarding arbitral objects that compose works of a project,
a project change influence inference step that infers and specifies objects which are influenced by said project program change in response thereto,
a stake holder inference step that infers and specifies stake holders who are relevant to said objects inferred and specified in said project change influence inference step, and;
an information notice step that notifies information regarding influence of contents of program change to those stake holders who are inferred and specified by said stake holder inference step.
